(19) United States
(12) Patent Application Publication
(10) Pub. No.: US 2024/0233417 A1
(43) Pub. Date: Jul. 11, 2024

(54) Microscopy System and Computer-Implemented Method for Determining a Confidence of a Calculated Classification

(71) Applicant: Carl Zeiss Microscopy GmbH, Jena (DE)

(72) Inventors: Manuel Amthor, Jena (DE); Daniel Haase, Zoellnitz (DE)

(21) Appl. No.: 18/405,578

(22) Filed: Jan. 5, 2024

(30) Foreign Application Priority Data
Jan. 10, 2023 (DE) 10 2023 100 440.9

(51) Int. Cl. G06V 20/69; G06V 10/776; G06V 10/82

(52) U.S. Cl. CPC G06V 20/698; G06V 10/776; G06V 10/82

(57) ABSTRACT

In a computer-implemented method for determining a confidence of a calculated classification, a microscope image is processed with an ordinal classification model, which calculates a classification with respect to classes that form an order. The ordinal classification model comprises a plurality of binary classifiers which, instead of calculating classification estimates with respect to the classes, calculate classification estimates with respect to cumulative auxiliary classes, wherein the cumulative auxiliary classes differ in how many consecutive classes of the order are combined. The classification is calculated from the classification estimates of the binary classifiers. A confidence of the classification is determined based on a consistency of the classification estimates of the binary classifiers.

### REFERENCE TO RELATED APPLICATIONS

The current application claims the benefit of German Patent Application No. 10 2023 100 440.9, filed on Jan. 10, 2023, which is hereby incorporated by reference. The contents of German patent application 10 2021 125 576.7 filed on Oct. 1, 2021 with the title “Method for the Ordinal Classification of a Microscope Image and Microscopy System” are incorporated herein by reference; concrete connections between the cited patent application and the present invention are explained in more detail later on.

### FIELD OF THE DISCLOSURE

The present disclosure relates to a microscopy system and a computer-implemented method for determining a confidence of a calculated classification. The classification is calculated by an ordinal classification model, which calculates a classification into one of a plurality of classes that form an order.

### BACKGROUND OF THE DISCLOSURE

The importance of the role of image processing is continuously increasing in modern microscopes, which are using machine-learned models on an increasing scale.

Ordinal classification models constitute a class of machine-learned models. Ordinal classification models are used for classification when the possible classes form a logical order. Classes in an order can indicate, e.g., the size of an object of interest in a microscope image. Three classes can be labelled, e.g., “2 px to 4 px”<“4 px to 8 px”<“8 px to 16 px”, wherein px designates the object size of the microscope image in pixels. These three classes form a logical order with respect to their classification criterion (i.e. object size). An example of a classification model without ordinal classes, on the other hand, would be a classification of a sample carrier type in an overview image in which the classes “microtiter plate”, “chamber slide” and “Petri dish” are discriminated. In order to discriminate a plurality of classes, a classification model comprises a plurality of binary classifiers that respectively output two different outputs (given class is present: yes/no) or a corresponding probability. With an ordinal classification model, the underlying order can be utilized in order to combine the outputs of the binary classifiers into an overall classification in a meaningful manner.

In order to take class order into account in an ordinal classification, special auxiliary classes can be employed, as described in: Frank E., Hall M., ‘A Simple Approach to Ordinal Classification’, Conference Paper in Lecture Notes in Computer Science, August 2001, DOI: 10.1007/3-540-44795-4_13.

Special ordinal classification models that utilize auxiliary classes to process microscope images have also been described by the Applicant in the German patent application DE 10 2021 125 576 filed on Oct. 1, 2021. The auxiliary classes comprise different numbers of the classes, which are consecutive according to the order. For example, the first auxiliary class can comprise all classes except for the first class, the second auxiliary class can comprise all classes except for the first two classes, while a third auxiliary class can comprise all classes except for the first three classes, etc. The binary classifiers of the ordinal classification model respectively indicate an estimate of a membership of the input microscope image in the corresponding auxiliary class.

In principle, tasks such as an object size estimation can also be performed with regression models instead of ordinal classification models. In the training for these different model types, different metrics are generally used in the loss function to be optimized as well as different optimizers. The optimizer determines how model parameter values are modified to minimize the loss function and has a large impact on the resulting model quality or training time. A regression model can use, e.g., a regression metric such as an L1 loss or L2 loss and an Adam optimizer. In ordinal classification models, on the other hand, a classification metric such as a loss based on a binary cross-entropy loss can be used as well as, as an optimizer, e.g., an SGD optimizer (SGD: stochastic gradient descent). The use of an ordinal classification model can be preferrable to a regression model.

In microscopy, the outputs of an ordinal classification model can be subsequently utilized within the framework of an automated workflow or can be interactively displayed to a user. It is important in this connection that erroneous classification results are automatically detected as erroneous in order to avoid problems in subsequent steps. There is thus a need for a confidence measure that indicates a reliability or accuracy of the result of the learned model. Confidence measures suited to regression models and to “normal” (i.e. non-ordinal) classification models are known. If these are applied naively to the case of ordinal classification, however, the ordinal character of the classification is not taken into account. The confidence measure may not be meaningful as a result.

For non-ordinal classification models, a confidence is determined, e.g., based on the distribution of the probability output vector of the classification model. The probability output vector is made up of the probabilities output by the different binary classifiers of the classification model. A high confidence is established when the probability output vector has a high value merely for a single class. If this approach is applied naively to the binary classifiers of an ordinal classification, the order of the classes and the interrelationship of the single classifiers are not taken into account.

The following methods are known for the determination of the confidence of a prediction of regular regression models that map directly to a continuous value:
Determination of a confidence via the input of a plurality of transformed input images: In DE 10 2021 100 444 A1, different variants of an input microscope image are generated with minimal changes and are respectively input into a machine-learned image processing model. The outputs of this model should be largely identical. The greater the differences between the outputs are, the lower the confidence is. However, as it requires a plurality of inputs and consequently a plurality of prediction steps, this approach entails a multiplication of the runtime.
Prediction of a (Laplace) distribution (mean and variance) instead of just the target value, see section on pages 10-11 in M. Weigert et al., “Content-Aware Image Restoration: Pushing the Limits of Fluorescence Microscopy”, bioRxiv, doi: https://doi.org/10.1101/236463; 3 Jul. 2018. The mean of the distribution constitutes the target prediction and the variance is used to determine an uncertainty/confidence. The drawback here is that a predicted distribution can be learned incorrectly due to an overfitting (e.g., in cases of too little training data or an excessive model complexity) and can thus be meaningless.
Determination of a confidence based on a model ensemble, see section on pages 11-12 of the cited article by M. Weigert et al. In this case, a plurality of model instances are trained with the same training data but with a different initialization. The variance of the individual model outputs for the same input data is established and serves as a measure of confidence. The drawback here is that a plurality of models and consequently a plurality of prediction steps are required. This results in a multiplication of the runtime and memory requirements.

DE 10 2019 114 012 A1 describes a method for estimating a reliability of an image processing result by inputting the image processing result into a verification model that has been trained using examples of image processing results to be able to discriminate between presumably correctly processed results and erroneous results.

A confidence measure especially suited to ordinal classification is, however, unknown in the prior art. The confidence measure should be determinable without excessive computational requirements and should allow a statement regarding the dependability of the classification that is as reliable as possible. It is also preferable if the confidence determination can also be utilized for existing ordinal classification models without the need for model modifications or new model training runs.

### SUMMARY OF THE DISCLOSURE

It can be considered an object of the invention to indicate a microscopy system and a method which determine a confidence measure for an ordinal classification calculated for a microscope image, wherein the determined confidence measure should be as meaningful as possible and should not require an excessive amount of computation or measurement.

This object is achieved by the microscopy system and the method with the features of the independent claims.

In a computer-implemented method according to the invention for determining a confidence of a calculated classification, a microscope image is processed with an ordinal classification model. The ordinal classification model calculates a classification with respect to classes that form an order. The ordinal classification model comprises a plurality of binary classifiers (also referred to as single classifiers in the present disclosure) which, instead of calculating classification estimates with respect to the classes, calculate classification estimates with respect to cumulative auxiliary classes. The cumulative auxiliary classes differ in how many consecutive classes of the order are combined. The classification is calculated from the classification estimates of the binary classifiers. A confidence of the classification is determined based on a consistency of the classification estimates of the binary classifiers.

A microscopy system according to the invention includes a microscope for image capture and a computing device that is configured to carry out the computer-implemented method according to the invention.

The invention also relates to a computer program comprising commands which, when the program is executed by a computer, cause the computer to carry out the method according to the invention.

For a better understanding of specific embodiments of the invention, it can be intended, for example, that the auxiliary classes indicate object sizes in the following intervals: 2-4 pixels; 2-6 pixels; 2-8 pixels; 2-10 pixels and 2-12 pixels. If the binary classifiers estimate a high likelihood of membership for the auxiliary classes 2-10 pixels and 2-12 pixels, while the binary classifiers for all remaining auxiliary classes indicate a low likelihood of auxiliary class membership, these classification estimates are consistent;

the true object size could be, e.g., 9 or 10 pixels. Classification estimates would not be consistent, on the other hand, if a high likelihood of auxiliary class membership is estimated for the auxiliary class 2-6 pixels, while a low likelihood of auxiliary class membership is estimated for the auxiliary class 2-8 pixels; these statements constitute a logical contradiction since the auxiliary class 2-8 pixels comprises the auxiliary class 2-6 pixels in its entirety so that a lower classification estimate cannot be calculated for the auxiliary class 2-8 pixels according to the rules of logic. In cases of logical inconsistency, it is not possible to infer the true object size with certainty. The confidence of a calculated classification is accordingly lower in this example than in the previous example of consistent classification estimates.

Put more generally, the invention exploits the fact that the classes and the auxiliary classes made up of the classes form a logical order. The classification estimates should be consistent along this order. A confidence or dependability of the final classification can be derived from this fact. The approach utilizes the ordinal characteristics of the data without requiring an excessive additional amount of computing power or storage capacity for the confidence estimation. This stands in contrast to conventional methods of calculating a confidence, which calculate, e.g., an ensemble correspondence of a plurality of models for the same input data or which calculate a correspondence between the outputs for different, minimally diverging input data. In these cases, the computational requirements are considerably greater and the ordinal character is not taken into account in the determination of the confidence.

### Optional Embodiments

Variants of the microscopy system according to the invention and of the method according to the invention are the object of the dependent claims and are explained in the following description.

### Classes and Auxiliary Classes

A type of the different classes is determined by the area of application of the ordinal classification model. The classes can relate in particular to depicted objects or image properties of a microscope image, for example a number of depicted objects of a certain object type or an image quality of the image. Different applications are explained in detail later on.

The classes form a logical order so that a value corresponding to the classes increases or decreases from a first class to a last class. For example, the number or size of depicted objects can increase from the first to the last class or the image noise can continuously increase from the first to the last class. The inverse order is also possible. The different classes can respectively designate neighboring, in particular contiguous, intervals. In the case of a classification according to the number of depicted objects, the classes can indicate, e.g., the following intervals: “0-5 objects”; “6-10 objects”; “11-20 objects”; “21-30 objects” and “31-50 objects”.

The auxiliary classes are formed so that one or more consecutive classes are combined in each auxiliary class. The auxiliary classes respectively differ in the number of combined classes. In the aforementioned example, auxiliary classes for the number of objects can be, e.g.: “0-5 objects”; “0-10 objects”; “0-20 objects”; “0-30 objects” and “0-50 objects”. The binary classifiers for these auxiliary classes thus have an order and form a series analogous to the order of the classes. The order of the binary classifiers can also be defined by a classification limit value of the associated auxiliary classes: an order of the auxiliary classes or associated binary classifiers is defined when the classification threshold value consistently increases (or consistently decreases) from one auxiliary class to the next.

Analogously, auxiliary classes can be formed so that, e.g., respectively one less class is included from one auxiliary class to the next. For example, the first auxiliary class can comprise all classes; the second auxiliary class can comprise all classes except the first class; the third auxiliary class can comprise all classes except the first and second classes, etc. Optionally, said first auxiliary class can be omitted. A training image with the annotation “membership in second class” is categorized as a member of the first and second auxiliary classes and as a non-member of further auxiliary classes.

Conversely, auxiliary classes can also be formed so that respectively one more class is included from one auxiliary class to the next. These auxiliary classes can also be called inverse auxiliary classes. For example, a first (inverse) auxiliary class can correspond to a first class of the order, a second (inverse) auxiliary class corresponds to the first and second classes of the order, a third (inverse) auxiliary class corresponds to the first to third classes of the order, etc. It is also possible in these configurations to generate auxiliary class annotations from class annotations. The auxiliary class annotations and associated microscope images are utilized to train corresponding binary classifiers. The addition of inverse auxiliary classes increases the stability of the model training. For each inverse auxiliary class, a corresponding binary classifier is added.

In general, classes can differ in both a lower limit and an upper limit, i.e. different classes never have the same lower limit or the same upper limit. Auxiliary classes, on the other hand, only differ in a single limit value. The limit values of the auxiliary classes can be precisely the lower limits of all classes or the upper limits of all classes. It is optionally possible to form an auxiliary class that comprises all classes and/or an auxiliary class that does not comprise any classes.

### Ordinal Classification Model

The model for ordinal classification (ordinal classification model) can comprise at least one neural network and can have been learned using training data. It comprises a plurality of binary classifiers, which are also called single classifiers and which respectively output an estimate (hereinafter: classification estimate) of whether one of the auxiliary classes or inverse auxiliary classes described in the foregoing applies to an input microscope image or to a section of the microscope image.

Outputs of the binary classifiers are input into a respective loss function in the training, whereby the binary classifiers are trained independently of one another. In principle, the binary classifiers can be formed by neural networks that are completely separate from one another. Alternatively, they can form different “heads” or end sections of a network with a common first section into which the microscope image is input.

Each binary classifier can calculate an output in the form of a probability that an auxiliary class associated with that classifier is present. For example, a binary classifier can output a probability that the auxiliary class “cell size ≥2 pixels” applies to a cell size of a biological cell of an input microscope image. Other binary classifiers determine the probabilities for the auxiliary classes “cell size ≥4 pixels” and “cell size ≥6 pixels”. From these classification estimates with respect to the auxiliary classes, it is possible to infer a classification with respect to the classes. In the cited example, the classes can be: “cell size 2 to 4 pixels”; “cell size 4 to 6 pixels” and “cell size 6 to 10 pixels”.

The ordinal classification model can in particular comprise one or more convolutional neural networks (CNNs). In particular a common first network section, which is followed by the different binary classifiers, can comprise a CNN. If the binary classifiers are formed by completely separate networks, without a common first section, then each of these networks can comprise a CNN. Model parameter values of the ordinal classification model, for example entries of convolutional matrices of a CNN, are defined using the training data, in particular with the help of microscope images with associated predetermined (auxiliary) class annotations. The parameter definition can occur iteratively by means of a learning algorithm, for example by means of a gradient descent method and backpropagation.

Microscope images can be used as input data in the training of the ordinal classification model, wherein a desired result (ground truth) can be predetermined in the form of an annotation for each of the binary classifiers for each microscope image. The annotation (hereinafter: auxiliary class annotation) can respectively indicate whether or not the microscope image belongs to the corresponding auxiliary class queried by the binary classifier. A plurality of auxiliary class annotations, corresponding to the number of (single) binary classifiers, can thus be utilized for each microscope image. These auxiliary class annotations can be automatically determined from a single annotation that indicates the particular class to which the microscope image belongs. In a training of the ordinal classification model, discrepancies between the classification estimates of the binary classifiers and the auxiliary class annotations are captured in a loss function. This loss function should be minimized, to which end model parameter values are iteratively adjusted. In contrast to, e.g., a regression model, the result that is ultimately sought (the classification) does not enter the loss function in this type of ordinal classification model, but rather the intermediate results of the different single classifiers.

A (single) binary classifier can be a program or a calculation rule, for example a neural network or a part of the same, which discriminates whether or not a property is present, in the present context whether the case “is a member of the auxiliary class” or the opposite case “is not a member of the auxiliary class” applies. The output of a binary classifier can in principle be one of two possible values in order to discriminate the aforementioned cases, e.g., by the values 0 and 1. Alternatively, the output is an estimate or probability of the presence of the property, in this case the property “is a member of the auxiliary class”. The output can take any value in the interval 0 to 1, wherein a larger value indicates a higher probability of membership in the corresponding auxiliary class. A binary classifier is provided for each auxiliary class, wherein there can in particular be three or more auxiliary classes and corresponding binary classifiers.

The classification is determined from the classification estimates of the binary classifiers. For example, the classification estimates can be added to form a total score. The estimates of all binary classifiers (for the auxiliary classes or for the inverse auxiliary classes) are combined in the total score, wherein in principle other mathematical operations are also possible instead of a summation. The total score rounded to a whole number designates the number of a class, thus realizing the classification. The classification can thus in particular indicate a selection of one of the classes. Alternatively, the classification or the total score can represent any value within a continuous number range, wherein the classes or their limit values correspond to certain values within that number range. The classification thereby enables an in principle more precise statement than would be possible by means of a simple selection of a class from a limited number of classes. A regression can be implemented with the ordinal classification model this way, in particular an image-to-scalar or image-to-image mapping.

A conversion of the total score to a value in a continuous value range can occur via a function by means of which a class number or number of an auxiliary class is mapped to a limit value of the class/auxiliary class, as described in greater detail below. Limit values of an image property are predetermined for the classes and thus also for the auxiliary classes, wherein the limit values discriminate neighboring classes or auxiliary classes from one another. If the limit values 4.0 pixels and 4.8 pixels are predetermined, among others, for the image property “average object size”, for example, one of the classes covers the interval from 4.0 to 4.8 pixels. For auxiliary classes, these limit values indicate minimum values, i.e. an auxiliary class covers the range “object size ≥4.0 pixels” and an auxiliary class covers the range “object size ≥4.8 pixels”. Inverse auxiliary classes can use these limit values as upper limits, i.e. an inverse auxiliary class covers the range “object size <4.0 pixels” and an auxiliary class covers the range “object size <4.8 pixels”. A function that maps the number of the auxiliary class to the corresponding limit values can be predetermined or determined (iteratively). The limit values can also have been initially defined precisely by this function, i.e. the values 1, 2, 3, etc. are inserted into the function in order to define the corresponding limit values. The total score can now be increased by 0.5 and inserted into this function in order to calculate (instead of a limit value) the value of the image property that is sought. The increase by 0.5 results from the fact that, at a limit value, the relevant binary classifier should return a high uncertainty and thus a value of approximately 0.5 while a whole number was entered into the function in the definition of the limit value.

In the inference phase following the completion of the training, it is not necessary to use classes that correspond in their interval limits to the auxiliary classes used in the training: if a mapping to a continuous value range occurs via the total score, the value range can be subdivided into any desired new classes once training has been completed. This can be useful, e.g., when the classes indicate a quality of the microscope image. If a user wants only microscope images of a particularly high quality to be selected, he or she can adjust the corresponding class limit accordingly after completion of the training.

If inverse auxiliary classes are optionally also used, a further total score is calculated from the estimates of the binary classifiers for the inverse auxiliary classes. This further total score should ideally equal the total score of the binary classifiers. A discrepancy between the two total scores indicates inaccuracies in the estimate. The two total scores can be averaged, wherein their difference is used as an additional measure of confidence.

The design of the classes, auxiliary classes and optional inverse auxiliary classes, the calculation of a total score, the use of the total score for classification or for mapping to a value in a continuous interval, and a subsequent modification of class interval limits after completion of the training can be as described in DE 10 2021 125 576.7, the contents of which are incorporated herein by reference.

The confidence calculation described in the present disclosure can be added to existing ordinal classification models provided that it is possible to access the results of the single classifiers of the ordinal classification model. It is thus advantageously generally not necessary to redesign or retrain an existing ordinal classification model for the confidence calculation. Rather, the confidence determination can be added by utilizing the outputs of the binary classifiers of the ordinal classification model.

### Confidence

The calculated confidence constitutes a measure for a correspondence or consistency between the statements of the different binary classifiers for a given input microscope image. The confidence thereby indicates a dependability or accuracy of the classification, which is calculated from the statements of the binary classifiers.

The confidence can be indicated as one of a plurality of confidence classes (e.g. low/medium/high confidence). Instead of such a discrete indication, the confidence can also be indicated as a value on a continuous number scale.

The confidence can optionally indicate a precision or an error range of the value determined by the classification. As described in greater detail later on, it is possible to determine, e.g., an edge in a curve of classification estimates. Classification estimates are very certain (close to 1 or 0) before and after the edge, while classification estimates across the width of the edge are less certain. It is thus possible to use the width of the edge as an error range for the value resulting from the classification. The edge can, e.g., start at the binary classifier no. x and end at the binary classifier no. y. The limit values of the binary classifiers x and y constitute the limits of the error range/precision. In the example of a size estimate with a gently sloping, wide edge, this can mean, e.g., that although the confidence for the calculated classification (e.g. “size=18 pixels”) is low, an interval can still be determined from the edge width in which the total output lies with a high probability, e.g. in the size interval 9 24 pixels, wherein 9 pixels and 24 pixels are the limit values of the binary classifiers no. x and no. y.

### Consistency Criteria for the Classification Estimates of the Binary Classifiers

The confidence can be determined as a plausibility of the classification estimates based on different consistency criteria.

In particular, the confidence can be determined to be lower, the more pronounced the inconsistencies between the classification estimates of the binary classifiers are. There is an inconsistency, for example, when the binary classifier for the auxiliary class “size of a depicted object lies between 2 and 4 pixels” outputs a higher probability of auxiliary class membership than the binary classifier for the auxiliary class “size of a depicted object lies between 2 and 6 pixels”. This inconsistency can be quantified via the difference between said probabilities. It can thereby be determined for the classification estimates of all binary classifiers whether there are any inconsistencies and, if so, how pronounced they are. An overall value for inconsistencies can be calculated therefrom, which can be output as a confidence measure.

The binary classifiers form, as described, a series that corresponds to the order of the classes or auxiliary classes. A curve of the classification estimates over this series of binary classifiers can be analyzed in order to determine the consistency.

For example, it can be taken into account for the confidence determination whether the curve of the classification estimates is monotonic, i.e. whether it continuously rises or continuously falls. In the case of a monotonic curve, the output classification probability always increases or always decreases along the series of binary classifiers. In this case, a higher confidence is inferred than in the case of a non-monotonic curve. In particular, a confidence can be inferred that is lower, the more the curve deviates from a monotonic curve. As a measure of monotonicity, it is possible to consider, for example, the slope at each point of the curve. The more the slope values alternate between positive and negative values, the more the curve deviates from a monotonic curve.

Alternatively or additionally, it is possible to determine an edge in the curve of classification estimates between classification estimates that indicate an applicability of the corresponding auxiliary class and classification estimates that indicate a non-applicability of the corresponding auxiliary class. The edge represents a transition from classification estimates with a high probability (e.g. defined as >x %, wherein x is between 70 and 90) to classification estimates with a low probability (e.g. defined as <y %, wherein y is between 10 and 30). The confidence is determined to be lower, the greater a width of the edge and/or the flatter a slope of the edge. The confidence can be indicated in the form of a precision or value range for a quantity quantified by the classification. The value range can be determined from the width of the edge, wherein the classification limit values of the corresponding auxiliary classes are used. The value range can be defined, e.g., by the two classification limit values of the two binary classifiers at which the edge starts and ends. The values for the start and end of the edge can also be determined by interpolating the classification limit values of adjacent binary classifiers.

In the case of a highest possible confidence, the curve of classification estimates exhibits a rapid drop with a single edge, i.e. the outputs up to an nth single classifier (binary classifier) all have a value close to 1 and the outputs as of the nth single classifier all have a value close to 0. If more than one edge is determined in the curve of the classification estimates, a lower confidence can be inferred. Formulated in greater detail, each classification estimate indicates a probability of an applicability of the corresponding auxiliary class, wherein the probability is expressed by, e.g., a value between 0 and 1. The confidence is determined to be higher, the closer all estimated probabilities are to 0 or 1; in these cases, most single classifiers are very reliable in their output. Whether the difference from 0 or the difference from 1 of a calculated probability is used for the confidence estimate is not defined simply as a function of whether the probability is closer to 0 or 1. Rather, an edge or an inflection point can be identified in the curve of classification estimates and the distance from the value 0 or 1 is determined for all classification estimates of classifiers on the same side of the edge/inflection point. For example, the difference from 0 is determined for all classification estimates of classifiers before the edge and the difference from 1 is determined for all classification estimates of classifiers after the edge, or vice versa. For example, the distance from 1 is calculated for the classification estimates before the edge when the mean value of the classification estimates before the edge is greater than the mean value of the classification estimates after the edge. Alternatively, knowledge of the design of the auxiliary classes can be exploited for this purpose: if there are fewer and fewer classes along the series of auxiliary classes, from one auxiliary class to the next, the classification estimates before the edge should be high (and the distance from 1 is used) while after the edge the classification estimates should be low and the distance from 0 is used.

Alternatively or additionally, the confidence can be determined to be lower, the more the curve of classification estimates deviates from a point symmetry. There should be a point symmetry in relation to a point at an edge center or at an inflection point in the curve of the classification estimates. A symmetry with respect to the number of classifiers before and after the symmetry point is not required in this connection.

To evaluate the curve of the classification estimates, a sigmoid function can first be fitted to the curve of classification estimates. Instead of the sigmoid function sig(x), it is also possible to use other “S”-shaped functions, such as, e.g., the hyperbolic tangent function tanh(x). The more precisely the fitted function describes the curve, the higher the confidence is. A deviation of a classification estimate from the (sigmoid) function can be given a stronger weighting, the further away this classification estimate is from an edge or inflection point of the sigmoid function, or the further away the binary classifier of this classification estimate is from the classifier whose classification estimate forms the inflection point or is closest to the inflection point. This weighting takes into account that the classifiers that are further away from a decision range should be particularly reliable and a deviation at these points indicates an erroneous image analysis.

The curve of classification estimates can also be evaluated based on a Fourier analysis. In principle all evaluation steps described here can occur in a frequency space; a mapping into the frequency space occurs by means of a Fourier transformation or Fourier analysis of the curve of classification estimates. The composition of the occurring frequencies allows statements regarding the curve of the classification estimates and, by implication, inferences regarding the confidence. It is possible to store frequency spectra or criteria that represent different confidence levels. In the case of a sigmoidal curve, which stands for a high confidence, low and high frequencies occur more frequently while medium-high frequencies occur less frequently, so that a low confidence can be inferred if there is a high proportion of signals of medium-high frequencies.

Alternatively, it is also possible to fit a polynomial to the curve and to then analyze the coefficients of the polynomial, similarly to the evaluation by means of a Fourier analysis.

The confidence can additionally or alternatively also be estimated from the information-theoretical entropy of all single classification outputs. Entropy serves as a measure of the degree of “disorder” or of the changes between the outputs of the classifiers. Ideally, the curve of the outputs should switch abruptly between a curve section with constant values close to 0 and a curve section with constant values close to 1. In this case, the entropy is relatively small. The confidence can be determined to be lower, the higher an entropy of the curve of the output classification estimates is.

The classification estimates or quantities derived therefrom can also be input into a machine-learned confidence estimation model that has been trained using training data to calculate a confidence of the classification from classification estimates or quantities derived therefrom. In the case of a supervised learning, the confidence is predetermined in the training data in the form of an annotation. The annotations can have been defined (in a manual, automated or semi-automated manner) based on the consistency criteria described in the present disclosure. Classes such as high/medium/low confidence or values in a continuous interval can be employed in this context. Instead of classification estimates in the form of scalars, data derived therefrom can be input into the confidence estimation model. For example, a representation of the classification estimates as a graph or image can form the input into the confidence estimation model. In this case, the model can in particular be designed with a CNN (convolutional neural network). The results of the approaches cited above, e.g., polynomial coefficients, Fourier coefficients, entropy and/or information on the monotonicity or slope of the curve of the classification estimates, can also serve as inputs.

If inverse auxiliary classes are used in addition to auxiliary classes, a curve of the classification estimates of the classifiers of the auxiliary classes as well as a curve of the classification estimates of the classifiers of the inverse auxiliary classes is calculated. To calculate the confidence, a consistency between the two curves is determined. For example, the respective edges of the two curves should lie in the same interval and intersect. The more the intervals of the edges differ, the lower the confidence is. The confidence can also be determined to be lower, the more the (absolute) slopes of the edges of the two curves differ.

### Application of the Ordinal Classification Model

The ordinal classification model can be an image processing model, which can in particular be configured to calculate at least one of the following as a classification from at least one input microscope image:
geometric information or quantity information pertaining to depicted objects, e.g., a size, a height level, an elevation or orientation of one or more objects; a number of depicted objects; or a confluence. A confluence refers here to a proportion of the surface area of the microscope image that is covered by objects of a certain type. Ascertaining an elevation can be desirable, for example, for determining a height of multiwell plates, of other sample carriers or generally of other structures. In the case of an oblique view, an elevation can be estimated in particular from a perspective distortion of the image content. Possible classes that form an order in a height estimation relating to multiwell plates can be, e.g.: Height=“15 mm”; “16 mm”; “17 mm”, etc. A quantity of gradually evaporating immersion medium can also be estimated, wherein the classes designate different quantities of immersion medium.
an object status, e.g. a fill level of a sample well; a degree of development/maturation of biological structures or a color of sample structures, wherein different colors are categorized into different consecutive classes according to associated spectral ranges.
an image property relating to the image itself, e.g., an image noise, an image brightness, an image sharpness, and/or an image quality. These properties can relate to the entire image or to a part of the same; for example, an image noise or a defocus can be respectively determined locally and separately for different regions of a microscope image. An ordinal classification of the image quality can comprise, e.g., the classes “reject” (for low image quality), “warn” (for medium-high image quality) and “accept” (for high image quality). In cases of acceptance, the microscope image is used for a provided subsequent process, while in cases of rejection the microscope image is not used further. A warning of the user occurs in order to communicate an uncertainty regarding a further use of the microscope image.
a focus position of depicted objects or structures, wherein possible classes that form an order can be, e.g.: “−250 μm”, “−200 μm”, . . . , “+250 μm”. A correct or desired focus position in this example is 0 μm.
a warning regarding analysis conditions, microscope settings, sample characteristics or image properties. Microscope settings can relate to, e.g., the illumination intensity or other illumination settings, detection settings or a focus.
a determination of imaging parameters with which a subsequent microscope image is to be captured.
a determination of parameters for a calibration, e.g., a determination of a position and/or orientation of at least one camera.
an indication regarding a future maintenance (predictive maintenance). In particular, this can be an indication of a degree of wear of a particular microscope component and/or a degree of miscalibration or whether a recalibration is required. Different classes indicate, e.g., different degrees of wear or different degrees of miscalibration.
an evaluation (model verification result) of a model output, of a machine-learned model or of a model architecture of a machine-learned model, for example of a model designed by Auto-ML. The evaluation can occur after completion of a model training or during a model training that is still in progress (training observer). The model can be an image processing model designed to calculate one of the properties described herein, e.g. an object size, a number of objects or a focus. The evaluation of a model output of an image processing model can be used in order to calculate a refinement of model parameters of the image processing model by way of a continuous active learning.
an output image. In this case, the possible classes indicate different grey values or pixel values. A classification thus defines a grey value/pixel value for a particular pixel of the output image. A corresponding classification is calculated for each pixel of the output image. This occurs for each color channel in cases where the output image comprises a plurality of color channels. Output images can be calculated for different applications: e.g., an output image can be calculated in which certain objects are more clearly visible or are depicted in a higher image quality compared to the microscope image or in which a depiction of certain structures is suppressed. The improved visibility or higher image quality can generally relate to depicted objects, as, e.g., in the case of a noise reduction (denoising), resolution enhancement (super-resolution), contrast enhancement (e.g. an adjustment of the gamma value or a contrast spread) or deconvolution. The improved visibility can also relate solely to specific objects, however, as in the case of a transformation between different contrast types, whereby a virtual staining of specific structures is achieved. In a virtual staining, an output image is calculated from a microscope image of a given contrast type, e.g. a phase-contrast image, wherein the output image corresponds to a different contrast type, e.g. a fluorescence image. Other possible contrast types are, for example, bright-field or DIC images (DIC: differential interference contrast). Fluorescence measurements with different excitation or detection wavelengths can also be considered different contrast types in this sense. A suppression of structures can occur, e.g., via an artefact removal or via a detail reduction of a background. The artefact reduction does not necessarily have to relate to artefacts already present in captured raw data, but can also relate to artefacts first caused by an image processing, in particular in the case of a model compression. A model compression simplifies a machine-learned model in order to reduce the memory or computational requirements of the model, wherein due to the model compression the model accuracy can be slightly reduced and artefacts can occur. An image-to-image transformation for calculating the output image can also relate to a filling-in of image regions (inpainting), e.g., a filling-in of defects or gaps as a function of surrounding image content. The output image can also be a density map of depicted objects, e.g., by marking cell or object centers. It is also possible for a white balance, an HDR image or a de-vignetting to be calculated. A white balance removes a distorting hue from the input microscope image so that colorless objects are actually depicted as colorless in the output image. In an HDR image, a scale of possible brightness differences per color channel is increased in relation to the input microscope image. De-vignetting removes an edge shading of the input microscope image or generally also other effects that increase towards the image edge, such as a change in color, errors in depiction or a loss in image sharpness. A signal separation (“unmixing”) is also possible in which one or more signal components are extracted, e.g. in order to estimate an extraction of a spectral range from a captured image.
a semantic segmentation, in particular a semantic instance segmentation, wherein a plurality of classes that form an order are discriminated. For example, the classes can indicate different minimum sizes of objects to be segmented, different degrees of contamination of depicted objects or different staining intensities of stained objects. For a semantic segmentation, analogously to the embodiments relating to an image-to-image mapping, a classification can relate to a single pixel of the resulting segmentation mask, so that a separate classification is calculated for each pixel. The classes can also designate different structures. In cases where the microscope image takes the form of an overview image to be segmented, an order of the structures can be formed, for example, by a distance of the structures from the actual sample. Different classes in an order of increasing distance from the sample can be, inter alia: “sample”, “coverslip region outside the sample”, “coverslip edges” and “retaining clips for the sample carrier”. An ordinal classification reduces the likelihood of drastic misclassifications, for example that image pixels are categorized as belonging to the class “sample” although these image pixels are directly adjacent to and surrounded by pixels categorized as “retaining clips for the sample carrier”.
a selection of images from an image dataset, wherein selected images resemble the input microscope image (image retrieval) and wherein the different classes indicate degrees of similarity between selected images and the input microscope image.

A type of training data of the ordinal classification model is chosen according to the aforementioned functions. For a supervised learning, the training data also comprises, besides microscope images, predetermined target data (ground truth data) that the calculated classification should ideally replicate. For a segmentation, the target data takes the form of, for example, segmentation masks. In cases of a virtual staining, the target data takes the form of, e.g., microscope images with a chemical staining, fluorescence images or generally microscope images captured with a different contrast type than the microscope images to be entered. A classification, however, is not (necessarily) calculated in the training, so that a discrepancy between the classification and the predetermined target data is not (necessarily) captured in a loss function. Rather, the binary classifiers of the ordinal classification model are trained by capturing discrepancies between their outputs (the classification estimates) and associated annotations derived from the aforementioned target data in a loss function to be minimized.

The ordinal classification model can in principle also be designed to process measurement data or microscope measurement data other than a microscope image. For example, this can be measurement data for determining an ordinal property of an object, in particular a size, temperature or quality. The measurement data can comprise, e.g., spectroscopic data, acoustic measurement signals, absorption data and chromatography measurement data. Instead of microscope images, it is also possible to use image data captured by devices other than microscopes.

### Subsequent Actions

A calculated confidence can be utilized for different subsequent actions, e.g., for:
displaying an uncertainty or predictive quality to the user. The confidence can be displayed to this end, e.g., in the form of a superimposition with the classification. If the confidence is output in the form of a numerical error range of a quantity indicated by the classification, this error range can also be entered into subsequent calculations for error propagation.
determining a dependability of the classification during an ongoing workflow carried out with the microscope. This allows a real-time monitoring of the model output. In an automated workflow, it can be decided based on the confidence whether the calculated classification should be used for a subsequent process. For example, the classification can relate to a sample carrier height to be considered for an automatic sample-stage movement. The sample-stage movement is only carried out in the event of a sufficient confidence, which reduces the risk of collisions with, e.g., the objective or other microscope components in the vicinity of the sample carrier.
determining whether the employed model is suitable for the data. In the event of an insufficient confidence, the ordinal classification model is categorized as unsuitable for processing the microscope image.
selecting a best-suited ordinal classification model from a group of pre-trained ordinal classification models based on the confidence respectively calculated for the same microscope image.
rejecting the classification in the event of a low confidence, so that, e.g., a workflow is discontinued; warning a user in the event of a medium-high confidence; and accepting the classification in the event of a high confidence, so that, for example, a workflow is continued automatically. For the three possible actions reject/warn/accept, the use of corresponding confidence classes (low/medium/high) is apt.
recommendation to a user or instruction to components of the microscopy system regarding a further training of the ordinal classification model. The quality of the ordinal classification model for the task at hand can be improved if a follow-up training (fine-tuning) is carried out with the help of the microscope image for which an insufficient confidence was established or with the help of similar microscope images. If the (at least one) confidence shows that contents of a microscope image or at least of a certain image region cannot be processed reliably, the corresponding image data should be selected for the follow-up training. The confidences can respectively relate to an entire image: e.g., the confidences can indicate that a size classification is possible with a high level of reliability for microscope images with objects of a size of 10-50 pixels, while the confidence is lower for microscope images with objects of a size of 4-10 pixels so that such microscope images should be selected for a follow-up training. Alternatively, the confidences can relate solely to image regions or pixels of microscope images. This is the case, for example, when the classification indicates a pixel of an output image and the confidence accordingly relates to this pixel. Image regions consisting of pixels of the microscope image for which classifications with an insufficient confidence were calculated are then selected for the follow-up training. A data selection for a follow-up training is in particular advantageous when further microscope images of the relevant sample regions are captured for this training. Photodamage to the sample should be kept low, so that new images should only be captured of the sample regions that are actually relevant. This approach is particularly important when the training of the ordinal classification model is carried out using microscope images of a sample for which microscope images are also to be captured and analyzed by means of the ordinal classification model after completion of the training. An example of such an application is the virtual staining mentioned above.

The use of a confidence is not limited to ready-trained ordinal classification models; rather, it is also possible to use a confidence during the training of the ordinal classification model in order to render the design of the model more robust. A confidence can be used, e.g., in an additional loss function that is to be minimized in the training so as to maximize the confidence. The training data should per se implicitly result in the desired properties from which the confidence is calculated (e.g., a monotonic curve with a sharply dropping edge). However, it is only by means of the confidence described here that correlations between the outputs of the single classifiers as well as the position of the threshold values of the single classifiers relative to the estimated classification are taken into account: for example, for a classifier close to the edge (decision limit), the error (i.e. the deviation of its classification estimate from 0 or 1) is less serious and thus to be given a weaker weighting than the error of a classifier further away from the edge.

### General Features

Formulations such as “based on”, “using” or “as a function of” are intended to be understood as non-exhaustive, so that the existence of further dependencies is possible. For example, the determining of a confidence of the classification based on a consistency of the classification estimates can also additionally take into account other factors, in particular the described correspondence between the curves for auxiliary classes and inverse auxiliary classes.

Descriptions in the singular are intended to cover the variants “exactly 1” as well as “at least one”. For example, exactly one microscope image can be input into the ordinal classification model or more than one microscope image can be input simultaneously into the ordinal classification model in order to calculate one (or more) classifications.

Objects depicted in a microscope image can be a sample or sample parts, e.g., particles, biological cells, cell organelles, viruses, bacteria, or parts of the same. Objects can also be coverslips or other parts of a sample carrier. Instead of the plural form “objects”, the described embodiments can also refer to just one object.

The microscope can be a light microscope that includes a system camera and optionally an overview camera. Other types of microscopes, however, are also possible, for example electron microscopes, X-ray microscopes or atomic force microscopes.

The computing device of the microscopy system can be designed in a decentralized manner, be physically part of the microscope or be arranged separately in the vicinity of the microscope or at a location at any distance from the microscope. It can generally be formed by any combination of electronics and software and can comprise in particular a computer, a server, a cloud-based computing system or one or more microprocessors or graphics processors. The computing device can also be configured to control microscope components. A decentralized design of the computing device can be employed in particular when a model is learned by federated learning by means of a plurality of separate devices.

The characteristics of the invention that have been described as additional apparatus features also yield, when implemented as intended, variants of the method according to the invention. Conversely, a microscopy system or in particular the computing device can be configured to carry out the described method variants.

Different descriptions relate to the training of the ordinal classification model. Variants of the method according to the invention result from the inclusion of the implementation of the training as part of the method. Other variants use a ready-trained ordinal classification model generated in advance according to the described training.

### BRIEF DESCRIPTION OF THE DRAWINGS

A better understanding of the invention and various other features and advantages of the present invention will become readily apparent by the following description in connection with the schematic drawings, which are shown by way of example only, and not limitation, wherein like reference numerals may refer to alike or substantially alike components:

FIG. 1 is a schematic illustration of processes of an example embodiment of a method according to the invention;

FIG. 2 shows a classification of classes and auxiliary classes used by an ordinal classification model according to example embodiments of the invention;

FIG. 3 is a schematic illustration of processes of an ordinal classification model within the framework of example embodiments of the invention.

FIG. 4 shows a curve of classification estimates of binary classifiers that corresponds to a high confidence;

FIG. 5 shows a curve of classification estimates of binary classifiers that corresponds to a medium-high confidence;

FIG. 6 shows a curve of classification estimates of binary classifiers that corresponds to a low confidence;

FIG. 7 is a schematic illustration of processes of an example embodiment of the method according to the invention;

FIG. 8 is a schematic illustration of an example embodiment of a microscopy system according to the invention.

### DETAILED DESCRIPTION OF EXAMPLE EMBODIMENTS

Different example embodiments are described in the following with reference to the figures.

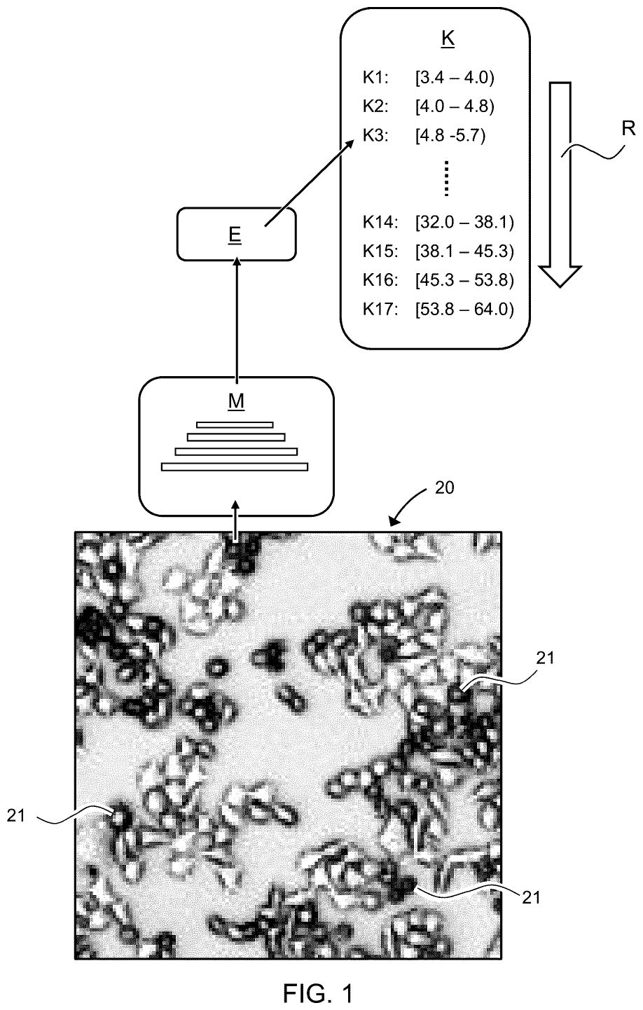

### FIG. 1

FIG. 1 schematically illustrates processes of a method for processing a microscope image 20 by means of an ordinal classification model M. This method can form part of a method according to the invention.

In the present example, a microscope image 20 to be processed shows a plurality of objects 21 (here: biological cells) and the ordinal classification model M is designed to estimate a size of the objects 21. In this example, the size is determined in pixels and designates the largest object diameter, although it is alternatively also possible for an object surface area in pixels to serve as a measure of the size. A size determination can be desired for a plurality or all of the depicted objects 21. In the following, the term “object size” can be understood as an average of the sizes of a plurality of objects 21 or of all objects 21 of the same image.

The microscope image 20 is input into the ordinal classification model M, which calculates a classification E from the microscope image 20. The classification E indicates one of a plurality of predetermined classes K. In the illustrated example, the classes K1 to K17 are predetermined and respectively indicate a size range. For example, the class K1 comprises the object sizes 3.4 to 4.0 pixels. The class K2 comprises the object sizes 4.0 to 4.8 pixels, etc. The classes K1 to K17 form a logical order R with regard to the property to be classified, in this case the object size. Ranges of the classes K1 to K17 can respectively be directly adjacent to one another, i.e. the upper limit of the class K1 is simultaneously the lower limit of the class K2; the upper limit of the class K2 is simultaneously the lower limit of the class K3, etc.

In the illustrated example, the classification E indicates that the class K3 has been determined to be applicable so that the (average) size of the objects 21 in the microscope image 20 lies in the interval 4.0 to 4.8 pixels.

How the ordinal classification model M works is described in greater detail with reference to the following figures.

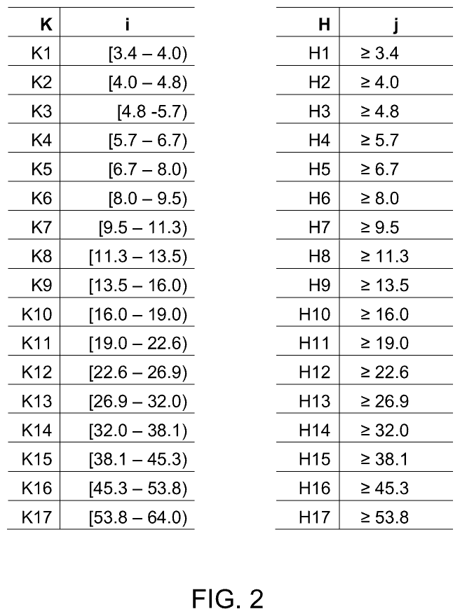

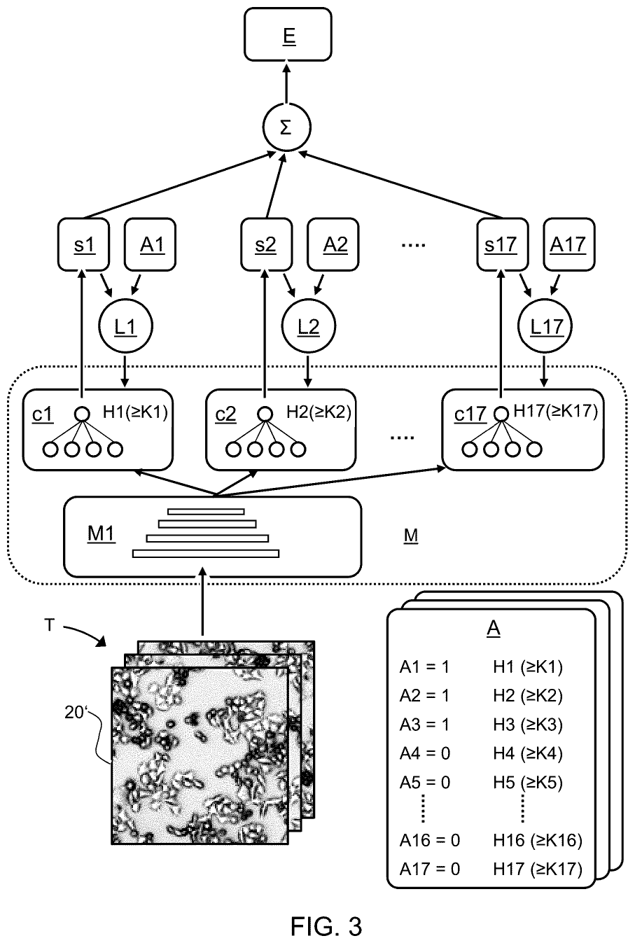

### FIG. 2 and FIG. 3

On the left, FIG. 2 shows a table with the classes K as employed for a size classification of the objects 21 of the microscope image 20 shown in FIG. 1. In the table, the left column indicates the respective number of a class K and the right column indicates the associated interval i. The first class K1 accordingly comprises objects with a size as of and including an interval lower limit of 3.4 pixels up to an interval upper limit of 4.0 pixels, wherein the interval upper limit does not belong to the interval i. The classes K form intervals i of different widths, wherein the width of an interval i is defined as the difference between its interval upper limit and its interval lower limit. An interval width increases with an increasing object size in this example. More generally, the interval width can increase with an increasing value of the image property according to which the ordinal classes K are formed.

The ordinal classification model does not utilize the classes K directly, however, i.e. the ordinal classification model does not comprise classifiers that estimate memberships in the classes K1-K17. Rather, the ordinal classification model comprises binary classifiers, which respectively estimate a membership in an auxiliary class H. The auxiliary classes are indicated in the table on the right in FIG. 2.

Each auxiliary class H utilizes a single limit value j, which in this example indicates an object size in pixels. While the classes K1-K17 respectively differ in an upper limit and a lower limit, the auxiliary classes H1-H17 only differ in a single limit value j.

In FIG. 2, the table on the right indicates the interval limit (the limit value) j for each auxiliary class H. The auxiliary classes H1 to H17 are formed by taking the lower interval limits of the classes K and using them as lower interval limits of the auxiliary classes H while upper interval limits of the auxiliary classes are not necessary. Alternatively, an upper interval limit could be defined so as to cover all objects, for example an upper interval limit of 64 pixels or more. The auxiliary class H2 comprises, for example, all object sizes as of and including 4.0 pixels with no upper interval limit. The auxiliary class H1 thus comprises all classes K1-K17; the auxiliary class H2 comprises the classes K2-K17; etc.

FIG. 3 schematically illustrates a training of the ordinal classification model M using training data T comprising a plurality of microscope images 20′.

Annotations A are predetermined for each microscope image 20′, wherein the annotations A indicate the correct classification for each auxiliary class H1-H17. Annotations A1-A17 are thus provided for the auxiliary classes H1-H17 for each microscope image 20′. In this example, the (auxiliary class) annotations A1-A17 have a value of 1 if the associated auxiliary class is present and a value of 0 if the auxiliary class is not present. For the illustrated microscope image 20′, the annotations A1-A3 have a value of 1 while all other annotations A4-A17 have a value of 0.

The microscope image 20′ is input into the ordinal classification model M, more precisely into a section M1 (backbone) of the ordinal classification model M. The section M1 can comprise a convolutional neural network (CNN), which can be designed, e.g., as a U-Net. The ordinal classification model M also comprises a plurality of single classifiers (binary classifiers) c1-c17, into which the output of the section M1 is respectively input. The classifier c1 is intended to calculate a classification estimate s1 with respect to the auxiliary class H1. The classification estimate s1 is a probability in the value range 0 to 1 and indicates the calculated probability that the auxiliary class H1 applies to the microscope image 20′. Analogously, each of the classifiers c2-c17 calculates a classification estimate s2-s17 with respect to the respective auxiliary class H2-H17.

In the training, the calculated classification estimate s1 is input into a loss function L1 that captures the difference from the associated annotation A1. An optimizer calculates a modification of the current model parameter values of the ordinal classification model M based on the loss function L1. This can occur, e.g., by means of a gradient descent method with backpropagation, so that the model parameter values of the classifier c1 and the section M1 are adjusted. The training is continued with updated model parameter values in order to minimize the loss function iteratively. This procedure is also carried out for the classification estimates s2-s17 of the remaining binary classifiers c2-c17. The associated loss functions L2-L17 can be designed identically to the loss function L1 and thus only differ in the input. After completion of the training, the ordinal classification model M should be able to calculate correct classification estimates s1-s17 (for the auxiliary classes H1-H17) for an input microscope image.

A classification E can be calculated based on the classification estimates s1-s17, e.g., by summing all classification estimates s1-s17. The calculation of a classification E does not necessarily have to occur in the training. The mathematical function for combining (e.g. summing) the classification estimates s1-s17 in order to calculate the classification E can be considered part of the ordinal classification model M or as a separate module that receives the outputs (classification estimates s1-s17) of the ordinal classification model M.

For the microscope image 20′ shown, the classification estimates s1-s17 can be, e.g.: 0.97; 0.94; 0.92; 0.03; 0.03; 0.03; 0.02; 0.02; 0.02; 0.02; 0.02; 0.01; 0.01; 0.01; 0.01; 0.01; 0.00; 0.00. The sum is 3.02. This (rounded) sum can be used as the number of the class K, so that the class K3 is determined. The object size is thus determined as 4.8-5.7 pixels.

The classification E can also be called a total score and does not necessarily have to be used in the form of a selection of one of the classes K1-K17. Rather, the classification E (the total score) can indicate a value on a continuous scale on which the classes K1-K17 indicate specific values (1, 2, 3, etc.) corresponding to their class number. This is explained in the following using the example of a microscope image that shows objects with an average size of 4.8 pixels. This size corresponds precisely to the limit value of the binary classifier c3 for the auxiliary class H3. In this example, the binary classifier c3 will be uncertain whether the object size is less than or equal to 4.8 pixels and will thus output a value of approximately 0.5. The sum of all classification estimates c1-c17 in this example can be approximately 2.5. It can be concluded from this sum that the object size is precisely at the limit between the ranges of the classes K2 and K3, i.e. at 4.8 pixels. The classification E can thereby indicate a more precise value than is possible by means of the widths of the classes K1-K17.

Similarly, a mapping of the classification/total score to a continuous number scale can also occur, which in this example is a continuous indication of the cell size in pixels. To this end, a function that maps the class number to the auxiliary interval limits is used. In the illustrated example, the auxiliary interval limits j are derived from the class numbers k by: j=2∧((k+6)/4), wherein k runs from 1 to 17, in order to calculate the limits for the auxiliary classes H1 to H17. The relationship between the total score S and the continuous object size Y is then given by: Y=2∧(S+0.5+6)/4) or, more generally, by replacing j with Y and replacing the variable for the class number k with (S+0.5) or with S plus a number greater than 0 and lower than 1. It is thereby possible to indicate a numerical value of a classified image property on a continuous numerical scale by means of binary classifiers, which enables a more precise indication than is possible via a designation of the interval of a class alone.

A statement regarding the accuracy or reliability of the calculated classification E, however, is still not provided in this case. Such a confidence that exploits the characteristics of an ordinal classification is provided by the invention. This is described in greater detail with reference to the following figures.

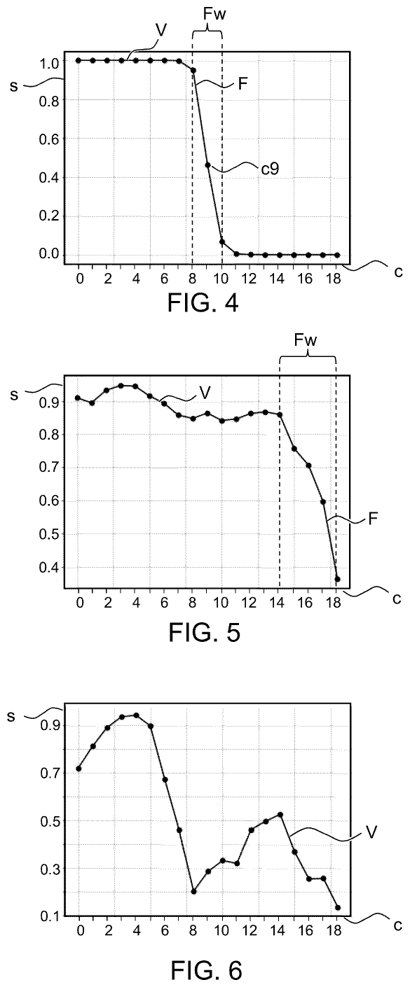

### FIGS. 4 to 6

FIGS. 4, 5 and 6 respectively show a curve V of the classification estimates s calculated by the binary classifiers c of an ordinal classification model. In this example, the model comprises nineteen binary classifiers c, which are numbered from 0 to 18 and designated c0-c18. The abscissa indicates the number of the binary classifier c. The order of the binary classifiers c reflects the order of the associated classes or auxiliary classes. The curve V indicates how the classification estimate progresses from one binary classifier to the classification estimate of the next classifier. All classification estimates s are calculated based on the same microscope image. The binary classifiers s0-s18 can follow one another in respectively equal intervals on the abscissa (as shown in FIGS. 4-6); alternatively, a respective interval between the binary classifiers can be chosen according to their classification threshold values. A compression/stretching of the curve changes as a function of this form of representation.

In FIG. 4, the curve V has a sigmoid shape. A plurality of consecutive classifiers c0-c8 each have a value close to 1 and a plurality of consecutive classifiers c10-c18 each have a value close to 0. An edge F between these two sets forms a steep transition with a relatively small width Fw. The classifier c9 lies in the middle of the range of the edge F and has a rounded value of 0.5. In this example, all classifiers except the classifier c9 in the range of the edge F output a result with a high level of certainty, which indicates a high level of dependability or confidence. The statements of all classifiers are also in harmony with one another, which is invariably the case with a monotonic curve V. For example, it would not be logically correct if the binary classifier c12 for the auxiliary class H12 were to output a larger value than both of the two binary classifiers c11 and c13 for the auxiliary classes H11 and H13. See also the example auxiliary classes of FIG. 2 in this connection: It is not logically possible that an object size ≥22.6 pixels is more probable than an object size >19.0 pixels because the auxiliary class “>19.0 pixels” contains the auxiliary class “>22.6 pixels” in its entirety. In the example of the curve V shown in FIG. 4, there are no such inconsistencies so that a high confidence of the classification is assumed. The width Fw of the edge F can serve as a measure of the precision of the classification. The limit values of the classifiers c8 and c10 delimiting the edge F can be used as error limits of the value or value range determined by the classifier.

This example illustrates that it is possible to make a statement regarding the reliability of the classification estimates and thus regarding the resulting classification based on the curve V of the classification estimates. The single classifiers are usually trained independently of one another, as described with reference to FIG. 3, although there is an implicit connection in the form of the design of the class intervals or the auxiliary classes.

FIG. 5 shows a curve V that does not have a sigmoid shape. Rather, the edge F (the sharp drop in the classification estimates s of the classifiers c15 to c18) extends up to an end of the series of binary classifiers. The curve V is also not monotonic, whereby, e.g., the value of the classifier c1 is not consistent with the value of the classifier c0. This suggests a lower confidence of the classification in comparison with FIG. 4.

FIG. 6 finally shows a curve V that deviates strongly from a monotonic curve. The curve also has scarcely any similarities with a sigmoid function. The statements of numerous classifiers contradict one another. For example, the classifiers c13 and c14 indicate a medium-high probability of the applicability of the corresponding auxiliary classes, while the binary classifiers c8 to c11 indicate a considerably lower probability; this is not logically possible with a classification into auxiliary classes analogous to the one shown in FIG. 2 and thus indicates inaccurate or erroneous results. The confidence of a classification is thus very low in the case of FIG. 6.

Different criteria can be used (individually or cumulatively) to quantify a confidence, which were described in detail in the general description and are explained in extracts in the following.

Monotony: A non-monotonic curve V indicates a contradiction between classification estimates. The more classification estimates deviate from values that would be necessary to form a monotonic curve, the lower the confidence is. Moreover, it is known whether the curve V should rise monotonically or fall monotonically. This depends on whether the series of auxiliary classes designates a set that decreases in size as in FIG. 2 (auxiliary class 8 comprises, e.g., all microscope images with objects equal to or greater than 11.3 while the next auxiliary class 9 comprises fewer microscope images, namely only those with objects equal to or greater than 13.5) or whether the series of auxiliary classes conversely designates a set that increases in size (if, e.g., the limit values of the auxiliary classes of FIG. 2 were to be formed by “smaller than” instead of “greater than/equal to”). In the first case, the curve should fall monotonically, as shown in FIG. 4, while in the second case the curve should rise monotonically. The confidence is determined to be lower if a rising curve is calculated for a curve that is expected to fall, and vice versa. Entropy: Information-theoretical entropy indicates the information content or the amount of data that is necessary to describe the curve V. In the case of a monotonic and sigmoidal curve V as shown in FIG. 4, entropy is low, whereas in the case of an inconsistent “muddle” of statements of the single classifiers, as shown in FIG. 6, the entropy is much higher. The confidence can thus be assumed to be higher, the lower the entropy is. Data compressibility can also be used as a measure of the entropy.
Point symmetry: The curve V shown in FIG. 4 is essentially point-symmetric in relation to a center point of the edge F, close to the classifier c9. A point symmetry, in particular in relation to a center point of the edge F, indicates a reliable classification in which the statements of the single classifiers are consistent with one another. In the examples shown in FIG. 5 and FIG. 6, however, the curve V deviates significantly from a point symmetry.

A method process sequence in which a confidence is calculated for a classification based on the described confidence criteria is described with reference to the following figure.

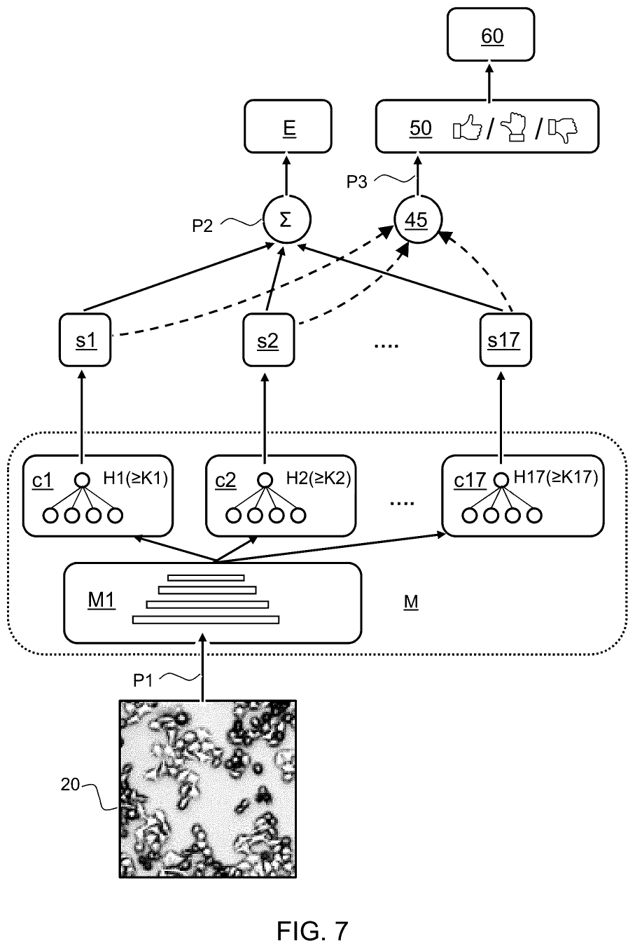

### FIG. 7

FIG. 7 schematically shows an example embodiment of a computer-implemented method according to the invention.

A microscope image 20 to be processed is input into the ordinal classification model M and processed by the same, process P1. The ordinal classification model M can have been trained as described with reference to FIG. 3. Each classifier c1-c17 of the ordinal classification model M calculates a classification estimate s1-s17 that indicates whether an auxiliary class H1-H17 associated with the respective classifier c1-c17 applies to the microscope image 20. The classification estimates s1-s17 are added together, e.g. summed, in a process P2 in order to calculate the classification E.

The classification estimates s1-s17 are also input into a confidence determination program 45, which calculates a confidence 50 from the classification estimates s1-s17 in a process P3. The calculation of the confidence 50 occurs based on the confidence criteria described in the foregoing.

The confidence determination program 45 can optionally be designed as a machine-learned confidence estimation model. Curves of classification estimates as shown in FIGS. 4 to 6 serve as training data of the confidence estimation model. The curves can also be input in the form of image data, whereby CNN-based networks are also suitable for the confidence estimation model. In the training data, an indication of confidence is annotated for each curve, e.g. a categorization as a low, medium or high confidence. The ready-trained confidence estimation model accordingly also calculates a confidence 50 in the form of a categorization into either a low, medium or high confidence class.

The confidence 50 is used in a subsequent action 60, e.g., for one or more of the following actions:
displaying the confidence 50 as an uncertainty or prediction quality to the user, e.g. in the form of a superimposition with the classification E.
for an automatic monitoring of the output of the ordinal classification model (output watchdog), it can be decided based on the confidence whether the calculated classification is to be used further in an (automated) workflow.
determining whether the employed ordinal classification model M is suitable for the microscope image 20 and/or a recommendation to the user or components of the microscopy system that further training (fine-tuning) is necessary with respect to the current data, in particular using data similar to the microscope image 20.
selecting a best-suited ordinal classification model from a collection of pre-trained models: A plurality of ordinal classification models can be trained and used to process the microscope image 20. The model is selected from among these models that delivers the best confidence. The corresponding classification E of the selected model is used further while the classifications of other models are discarded; alternatively, the classifications of different models are averaged and weighted according to the respective confidence. The selection of the best-suited ordinal classification model can also determine that subsequent microscope images are processed with this model alone.
determining selected or relevant image regions for which a follow-up training of the model is to occur. A confidence can be respectively calculated for each of a plurality of results respectively relating to a section or a pixel of the microscope image. This can be the case, e.g., with classifications that indicate an image sharpness pixelwise or by image region. In another example, each classification indicates a pixel value (grey value) of an output image and the confidences indicate precisions of the grey values. The follow-up training is intended to occur for image regions of the microscope image for which a classification was calculated with an inadequate confidence.

By means of the invention, it is generally possible to indicate a confidence measure for an ordinal classification that utilizes the underlying ordinal character of the data and does not entail excessive additional computational requirements.

The invention is not limited to the variant embodiments described herein by way of example. The microscope images can also show any other content instead of biological cells. In particular, the microscope images can also be overview images which show, e.g., a sample carrier. It is also possible for a plurality of microscope images or volumetric image data to form the input into the ordinal classification model. The classification does not have to relate to the size of depicted objects, but can instead target any quantity mentioned in the general description, e.g., a number of objects, a sample carrier contamination, an image quality or an image noise. The classification can also relate to a pixel of an output image. In this case, the ordinal classification model calculates a respective classification for each pixel of the output image. A confidence is calculated for each pixel from the associated classification estimates in this case, so that a corresponding confidence map is obtained for the output image, which indicates a respective confidence value for each pixel of the output image. The number of classes or auxiliary classes can have in principle any value greater than or equal to three. The auxiliary classes or associated classes used in the training do not have to be the same as a classification in the inference phase after completion of the training: the classification E can be calculated as a total score in a continuous value range that can be divided into different intervals (classes) after completion of the training, as described in the general description.

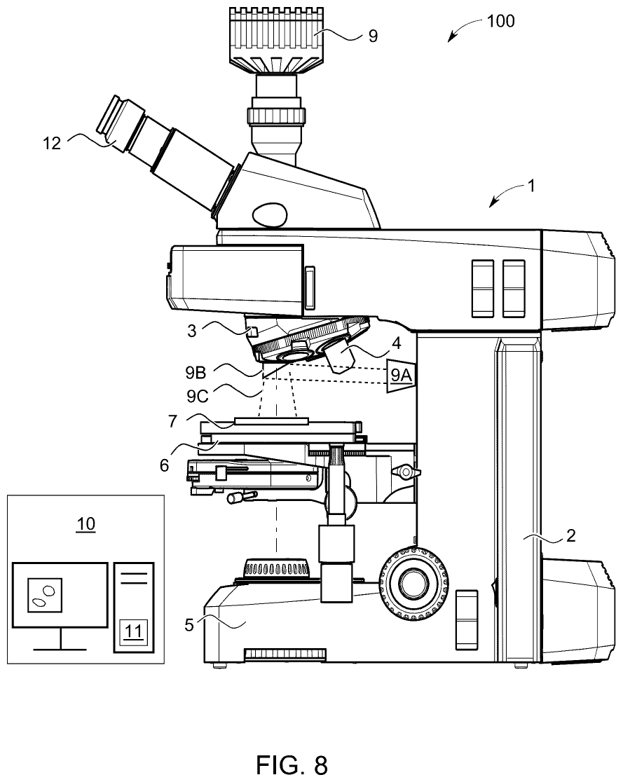

### FIG. 8

FIG. 8 shows an example embodiment of a microscopy system 100 according to the invention. The microscopy system 100 comprises a computing device 10 and a microscope 1, which is a light microscope in the illustrated example, but which in principle can be any type of microscope. The microscope 1 comprises a stand 2 via which further microscope components are supported. The latter can in particular include: an illumination device 5; an objective changer/revolver 3, on which an objective 4 is mounted in the illustrated example; a sample stage 6 with a holding frame for holding a sample carrier 7; and a microscope camera 9. When the objective 4 is pivoted into the light path of the microscope, the microscope camera 9 receives detection light from an area in which a sample can be located in order to capture a sample image. A sample can be any object, fluid or structure. An eyepiece 12 can also be used in addition to or instead of the microscope camera 9. The microscope 1 optionally comprises an additional overview camera 9A for capturing an overview image of a sample carrier 7. A field of view 9C of the overview camera 9A is larger than a field of view of the microscope camera 9. In the illustrated example, the overview camera 9A views the sample carrier 7 via a mirror 9B. The mirror 9B is arranged on the objective revolver 3 and can be selected instead of the objective 4.

A microscope image is understood in the present disclosure as raw image data captured by the microscope or data processed therefrom. The microscope image can in particular be an overview image of the overview camera 9A or a sample image of the sample camera/system camera 9. Captured microscope images can be used in the model training or in the inference phase after completion of the training in the variants of the method according to the invention described in the foregoing. The method can be carried out by a computer program 11 that forms part of the computing device 10.

The variants described with reference to the different figures can be combined with one another. The described example embodiments are purely illustrative and variants of the same are possible within the scope of the attached claims.

### LIST OF REFERENCE SIGNS

1 Microscope
2 Stand
3 Objective revolver
4 (Microscope) objective
5 Illumination device
6 Sample stage/microscope stage
7 Sample carrier
9 Microscope camera
9A Overview camera
9B Mirror
90 Field of view of the overview camera
10 Computing device
11 Computer program
12 Eyepiece
20 Microscope image
20 Microscope image of the training data
21 Objects in the microscope image
45 Confidence determination program
50 Confidence
60 Subsequent action
100 Microscopy system
A, A1-A17 (Auxiliary class) annotations
c, c1-c17 Binary classifiers/single classifiers
E Classification
F Edge
Fw Width of the edge
H, H1-H17 (Cumulative) auxiliary classes
i Interval of the classes
j Limit values of the auxiliary classes
K, K1-K17 Classes
L1-L17 Loss function(s)
M Ordinal classification model
M1 Section of the ordinal classification model
P1-P3 Processes of a method according to the invention
R Order of the classes
s, s1-s17 Classification estimates
T Training data of the ordinal classification model
V Curve of the classification estimates

What is claimed is:

1. A computer-implemented method for determining a confidence of a calculated classification, comprising:
processing a microscope image with an ordinal classification model in order to calculate a classification with respect to classes that form an order;
wherein the ordinal classification model comprises a plurality of binary classifiers which, instead of calculating calculation estimates with respect to the classes, calculate classification estimates with respect to cumulative auxiliary classes, wherein the cumulative auxiliary classes differ in how many consecutive classes of the order are combined;
wherein the classification is calculated from the classification estimates of the binary classifiers; and
determining a confidence of the classification based on a consistency of the classification estimates of the binary classifiers.

2. The method according to claim 1,
wherein the classification of the ordinal classification model classifies into one of a plurality of classes, which relate to one of the following:
a number, confluence or size of depicted objects in the microscope image; or
a quality statement regarding a sample, an image acquisition or an employed microscope component; or
brightness values of pixels of an output image calculated by the ordinal classification model, in particular a virtually stained, noise-reduced or resolution-enhanced output image.

3. The method according to claim 1,
wherein the confidence is determined to be lower, the more pronounced inconsistencies between the classification estimates of the binary classifiers are.

4. The method according to claim 1,
wherein the binary classifiers form a series corresponding to the order of the classes;
wherein the consistency is determined based on a curve of the classification estimates over the series of the binary classifiers,
wherein each classification estimate indicates a probability of an applicability of the corresponding auxiliary class.

5. The method according to claim 4,
wherein the confidence is determined to be lower, the more the curve deviates from a monotonic curve.

6. The method according to claim 4,
wherein an edge is determined in the curve of the classification estimates between classification estimates that indicate an applicability of the corresponding auxiliary classes and classification estimates that indicate a non-applicability of the corresponding auxiliary classes;
wherein the confidence is determined to be lower, the greater a width of the edge or the flatter a slope of the edge is;
wherein the confidence is estimated to be lower if more than one edge is determined in the curve of classification estimates.

7. The method according to claim 4,
wherein the confidence is determined to be lower if an edge in the curve of the classification estimates extends up to a start or an end of the series of the binary classifiers.

8. The method according to claim 4,
wherein the confidence is determined to be lower, the more the curve of the classification estimates deviates from a point symmetry.

9. The method according to claim 4,
wherein the curve of the classification estimates is evaluated by fitting a sigmoid function to the curve of classification estimates, and
wherein the confidence is determined based on deviations of the classification estimates from the fitted sigmoid function.

10. The method according to claim 9,
wherein a deviation of a classification estimate from the sigmoid function is given a greater weight, the further away said classification estimate is from an inflection point in the sigmoid function.

11. The method according to claim 4,
wherein the curve of the classification estimates is evaluated based on a Fourier analysis.

12. The method according to claim 1,
wherein each classification estimate indicates a probability of an applicability of the corresponding auxiliary class, wherein the probability is indicated with a value between 0 and 1,
wherein the confidence is determined to be higher, the closer all estimated probabilities are to 0 or 1.

13. The method according to claim 1,
wherein the confidence is determined to be lower, the higher an entropy of the classification estimates is.

14. The method according to claim 1,
wherein the classification estimates or quantities derived therefrom are input into a machine-learned confidence estimation model that was trained using training data to calculate a confidence of the classification from classification estimates or quantities derived therefrom.

15. The method according to claim 1,
wherein the ordinal classification model is trained with training data comprising microscope images and associated auxiliary class annotations,
wherein, in a training of the ordinal classification model, deviations of the classification estimates of the binary classifiers from the auxiliary class annotations are captured in at least one loss function to be minimized.

16. A microscopy system with a microscope for image capture; and
a computing device that is configured to carry out the computer-implemented method according to claim 1.

17. A computer program, comprising commands saved on a non-volatile, computer-readable medium and which, when the program is executed by a computer, cause the computer to carry out the method according to claim 1.
